(19) United States
(12) Patent Application Publication
(10) Pub. No.: US 2013/0140810 A1
(43) Pub. Date: Jun. 6, 2013

(54) Linearly-Actuated Low Stress Fluid Delivery Apparatus For Vacuum Environments

(71) Applicant: MDC VACUUM PRODUCTS, LLC, Hayward, CA (US)

(72) Inventors: Kenneth D. Ames, San Jose, CA (US); James W. Moore, Modesto, CA (US); Subhashish Sengupta, Vallejo, CA (US)

(73) Assignee: MDC VACUUM PRODUCTS, LLC, Hayward, CA (US)

(21) Appl. No.: 13/692,990

(22) Filed: Dec. 3, 2012

Related U.S. Application Data
(60) Provisional application No. 61/567,077, filed on Dec. 5, 2011.

(51) Int. Cl. F16L 51/02

(52) U.S. Cl. CPC F16L 51/02
USPC 285/226

(57) ABSTRACT

A connector comprised of a fluid delivery means for conveying a fluid to a component, a compliant tube that surrounds the fluid delivery means and that is fluid-tight, and a load transfer means positioned outside of the compliant tube for relieving stress on the compliant tube that arises when the compliant tube undergoes linear motion. The fluid delivery means may be the tubes that convey a cooling fluid to a component in a thin film plating apparatus. The compliant tube may be a tube that contains a bellows section. The load transfer means may comprise a pair of rods positioned outside of the compliant tube that run parallel to the compliant tube.

### BACKGROUND OF THE INVENTION

In a vacuum manufacturing environment, a fluid is frequently used to cool or service a component in an apparatus that is exposed to high vacuum. A critical design concern in such cases is that the fluid delivery system be sufficiently robust to prevent leakage of the fluid into the high vacuum environment. This problem is especially critical in systems where the fluid delivery system is exposed to additional stresses, such as from moving parts in the system.

One solution that has been used in the prior art, is to run the fluid through a bellows tube. Metallic compression seals at the end of the bellows tube are used to join the bellows tube to another component in a manner that prevents leakage of the fluid into the high vacuum environment. For example, U.S. Pat. No. 5,473,627, issued on Dec. 5, 1995, describes a fluid delivery system for use with a rotatable crucible in an electron beam thin film deposition chamber. The system uses two coiled bellows tubes as the water inlet and water outlet components. When the crucible is rotated, the coiled bellows tubes move to accommodate the rotational motion of the crucible. While such designs are useful, these systems sometimes fail prematurely and leak fluid into the vacuum environment. What is needed is a fluid delivery system that is not susceptible to developing leaks that allow fluid into the vacuum environment.

### BRIEF SUMMARY OF THE INVENTION

Briefly, the present invention comprises a connector comprised of a fluid delivery means for conveying a fluid to a component, a compliant tube that surrounds the fluid delivery means and that is fluid-tight, and a load transfer means positioned outside of the compliant tube for relieving stress on the compliant tube that arises while the compliant tube undergoes linear motion. The fluid delivery means may be a fluid inlet tube and/or a fluid outlet tube for conveying a cooling fluid to a component such as the crucible in a thin film plating apparatus. The compliant tube may be a metal tube that contains a bellows section, and the load transfer means may comprise a pair of rods that are positioned outside of the compliant tube and that extend in a direction that runs parallel to the length of the compliant tube.

### BRIEF DESCRIPTION OF THE SEVERAL VIEWS OF THE DRAWINGS

FIG. 1 is a cross-sectional view of a connector according to the present invention;

FIG. 2 is a side view of the connector according to the present invention;

FIG. 3 is a cross-sectional view of a crucible and part of the connector taken along the line 3-3 shown in FIG. 2;

FIG. 4 is a cross-sectional view of an end of the connector;

FIG. 5 is a cross-sectional view of another end of the connector;

FIG. 6 is an isomeric view of the bearing assemblies; and

FIG. 7 is another cross-sectional view of the connector according to the present invention.

### DETAILED DESCRIPTION OF THE INVENTION

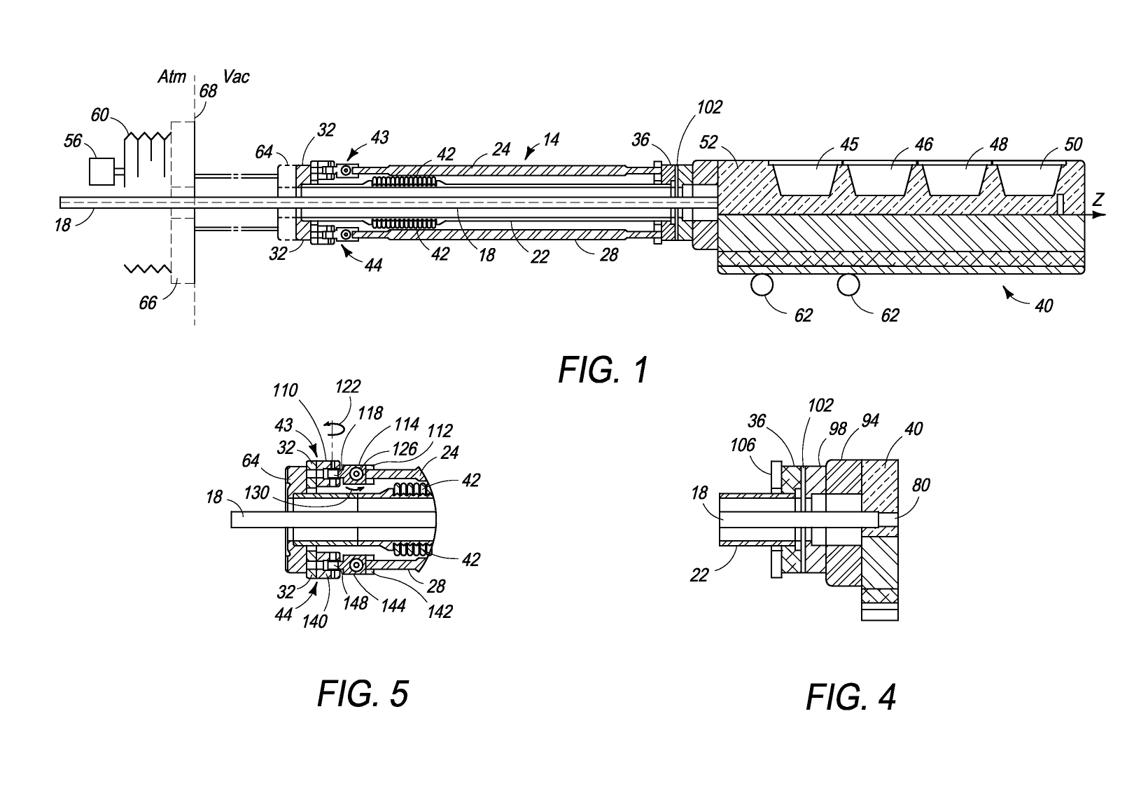

FIG. 1 illustrates a connector 14 comprised of a fluid delivery means 18, a compliant tube 22, an upper actuator rod 24, a lower actuator rod 28, a first weldment 32 attached to a first end of at least one of the actuator rods and a second weldment 36 attached to a second end of the one or more actuator rods. The fluid delivery means 18 conveys a coolant to a crucible 40. The compliant tube 22 surrounds the fluid delivery means 18 and includes a bellows section 42. The actuator rods 24 and 28 are positioned outside of the flexible tube 22 and the actuator rods 24 and 28 are attached to the first weldment 32 by a pair of attachment means 43 and 44.

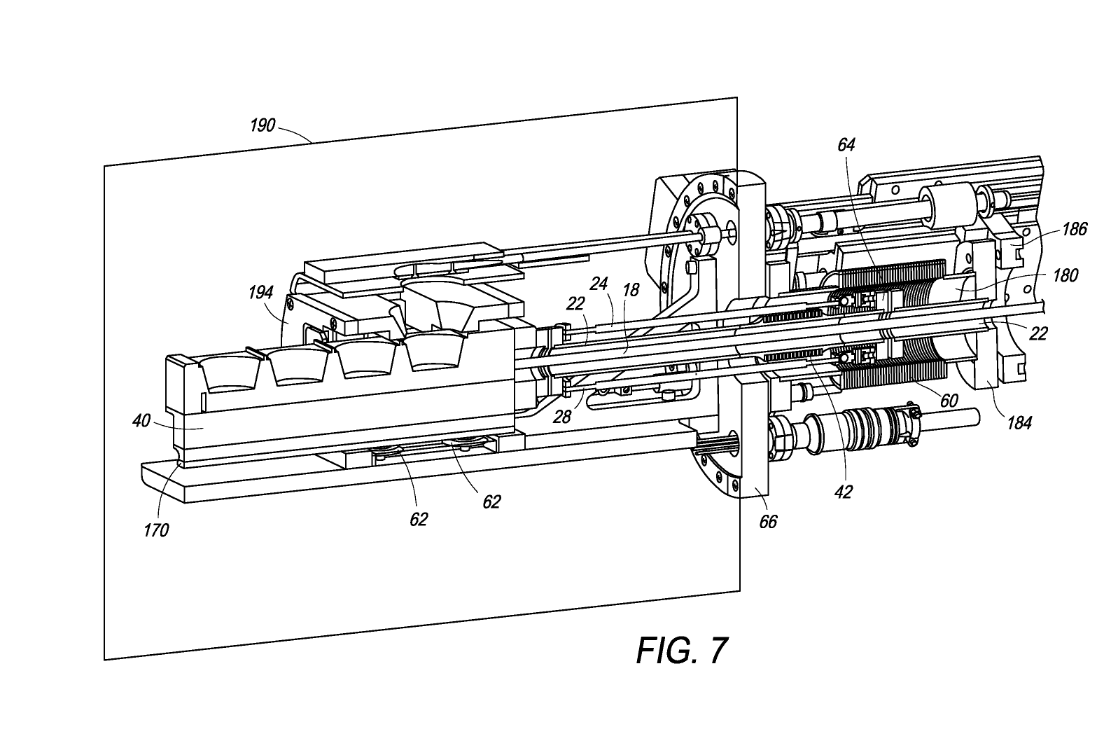

In a preferred embodiment, the crucible 40 is used in conjunction with an electron gun assembly 194 (shown in FIG. 7), such as an electron gun assembly typically used in a thin film plating operation. As is well known in the art, a substance to be plated is placed in a pocket in the crucible 40 and an electron beam is directed at the substance. Since the crucible 40 is maintained in a vacuum environment (i.e. pressures less than atmospheric), the electron beam causes the substance to vaporize and form a thin film on a substrate. In FIG. 1, the crucible 40 comprises a plurality of pockets, represented by the pockets 45, 46, 48 and 50. The pockets are oriented linearly in the horizontal direction, represented by the arrow “z” in FIG. 1. Preferably, the pockets 45, 46, 48 and 50 are frustoconical in shape and comprise hollowed out regions a pocket layer 52 of the crucible 40. Preferably the pocket layer 52 comprises a material such as copper, although other materials may be used.

In use, the electron beam (not shown) is typically aimed at a fixed position, for example at the center of the pocket 45 in FIG. 1. When one of the other pockets 46, 48 or 50 is to be utilized, that pocket must be translated (i.e. moved) into the position previously occupied by pocket 45. This translation is accomplished by a translation means 56, such as an actuator associated with a linear motion bellow 60. For example, an actuator comprised of a motor driven leadscrew or another type of linear actuator can be used as the translation means 56. Suitable linear actuator motors for this purpose are commercially available from sources such as Schneider Electric Motion USA of Marlborough, Conn., under the product designation MDrive 23 Plus (a NEMA size 23 high torque stepper motor). A suitable actuator/drive mechanism is commercially available from sources such as Trace Parts (Community of CAD users) under the product designation ECMU CSR, Part No. BG3305A-300H/R0 (actuator BG size 33, length 300 mm). The linear motion bellow 60 to is a welded bellow such as an edge welded metal bellows diaphragm commercially available from a source like BellowsTech, LLC of Ormond Beach, Fla., under the product designation 0403B.

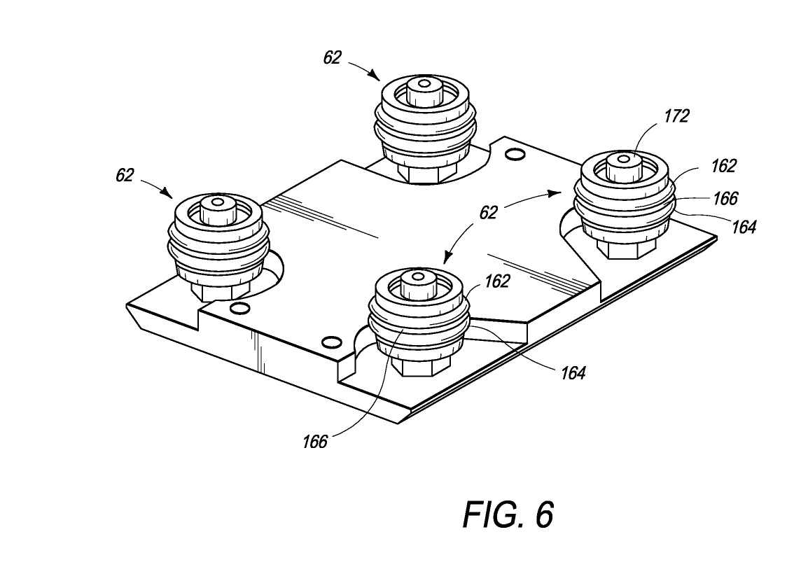

The crucible 40 is supported on a plurality of bearing assemblies 62 that provide the primary means of controlling the linearity of the crucible 40, meaning that a crucible can be repositioned in the same location originally occupied by the crucible 40, thereby making the plating process repeatable. For example, the bearing assembly 62 may comprise a double vee bearing assembly comprised of commercially available bearings, spacers and retainers, with the bearings mounted on a spindle and supporting a moving mating rail. The function of the bearing assembly 62 is to guide and control the motion of the crucible caused by the translation means 56. The bearing assembly 62 is shown in more detail in FIG. 6.

In operation, the connector 14 and the crucible 40 are positioned inside of a chamber 190 (shown in FIG. 7) that maintains a vacuum environment, such as the vacuum environment required for thin film plating using an electron beam. The linear motion bellow 60 is mechanically coupled to the connector 14 at the endplate 184 (shown in FIG. 7) so as to allow the actuator 56 to move the connector 14 in the horizontal (z) direction. The linear motion bellow 60 includes a sealing bellow interface 66 that is attached and sealed to the chamber that surrounds the crucible 40 and the connector 14. Atmospheric pressure exists to the left of the interface 66 as is indicated by a line 68, while a vacuum environment is maintained inside of the chamber to the right of the interface 66 (and to the right of line 68).

The linear motion bellow 60 provides a means for moving the connector 14 in the horizontal (z) direction while maintaining the high vacuum environment. A portion of the fluid delivery means 18 passes through the abutment 32, the plate assembly 64 and the interface 66 in a manner that preserves the vacuum environment, and extends inside the linear motion bellow 60. Preferably, the linear motion bellow 60 comprises a stainless steel bellows tube. The bellows are comprised of a plurality of stainless steel rings connected in an accordion-like structure as is well known in the art. Bellows tubing comprised of other materials may also be used as the linear motion bellow 60. The linear motion bellow 60 and its functioning are described in more detail below with respect to FIG. 7.

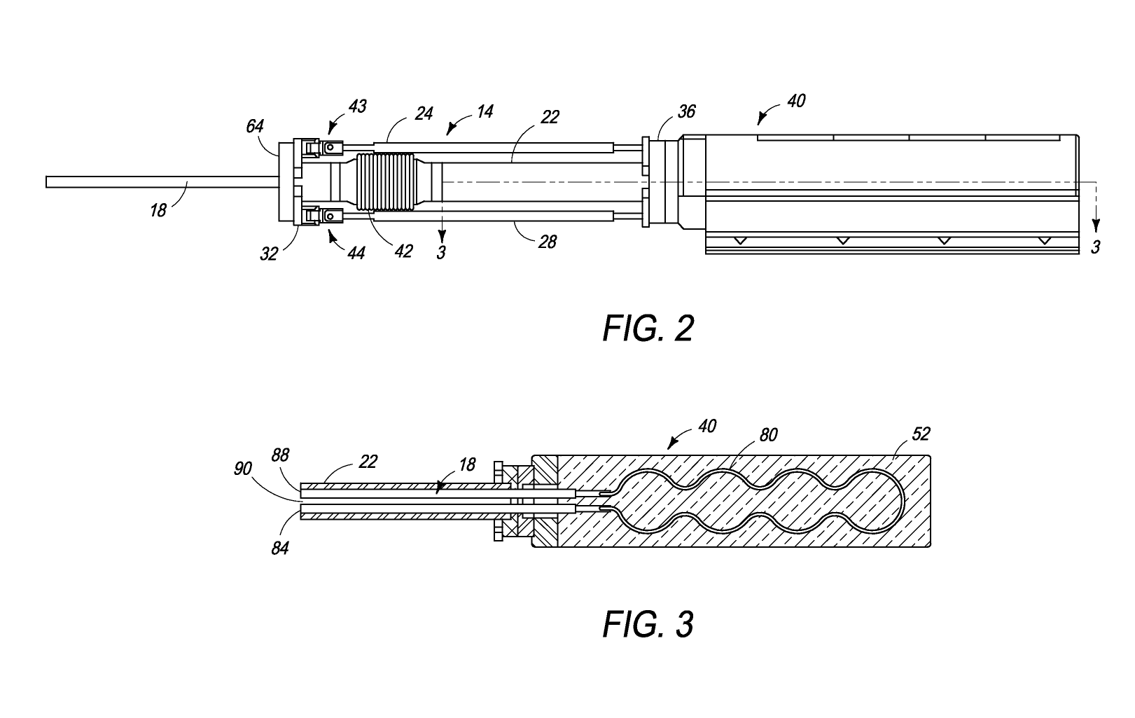

FIG. 2 illustrates that the compliant tube 22 completely encloses part of the fluid delivery means 18 and includes the bellows section 42. In a preferred embodiment, the compliant tube 22 comprises a stainless steel tube, and the bellows section 42 comprises a flexible part of the stainless steel tube that stretches in the horizontal (z) direction. This flexibility allows the compliant tube 22 to respond to any motion related stress it may encounter without experiencing material fatigue or failure, thereby alleviating any stress on the fluid delivery means 18.

Preferably, the bellows section 42 is also comprised of stainless steel and comprises a plurality of rings connected in an accordion-like structure as is well known in the art. The compliant tube 22 may be comprised of materials other than stainless steel. Preferably, the bellows section 42 is a formed bellows, such as the formed bellows commercially available from a source like Ameriflex, Inc. of Corona, Calif. under the product designation of GRAND™ medium wall hose, nominal ID of one inch.

The upper actuator rod 24 and the lower actuator rod 28 are struts that act as load transfer structures that bear most of the stress arising from the motion of the connector 14 in response to the actuator 56. Preferably, the upper actuator rod 24 (also called strut 24) and the lower actuator rod 28 (also called strut 28) comprise a material such as stainless steel, but other materials can be used. The upper actuator rod 24 is attached to the first weldment 32 by an attachment means 43. Similarly, the lower actuator rod 28 is attached to the first weldment 32 by an attachment means 44.

The attachment means 43 and 44 can be identical joints that each comprises two pivoting joints at right angles which give the joint two degrees of freedom. A fastener is used to attach the attachment means 43 or 44 to the first weldment 32. Preferably, the fastener is a screw or a stud/nut combination, but other types of fasteners may be used, such as a weldment. The configuration of the attachment means 43 and 44 is illustrated in more detail in FIG. 5. The upper actuator rod 24 and the lower actuator rod 28 each extend in a direction parallel to the compliant tube 22, and each of the rods 24 and 28 are sufficiently rigid to allow the compliant tube 22 to undergo linear motion, while being sufficiently flexible to relieve stress on the compliant tube 22 when necessary. Furthermore, as is described in more detail below with respect to FIG. 5, preferably the rods 24 and 28 can pivot slightly in at least one direction that is not parallel to the direction of the linear motion.

FIG. 3 illustrates that the fluid delivery means 18 is connected to a fluid channel 80 inside of the crucible 40. In the preferred embodiment, the fluid delivery means 18 comprises an inlet fluid tube 84 and an outlet fluid tube 88. Preferably, the fluid channel 80 is a continuous hollow channel that is machined into the pocket layer 52 so that fluid can flow through the fluid channel 80 without leaking out of the crucible 40 into the vacuum environment that surrounds the outside of the crucible 40. The fluid channel 80 wraps around each of the pockets 45, 46, 48 and 50, with the inlet fluid tube 84 connecting to a first end of the fluid channel 80 and the outlet fluid tube 88 connecting to a second end of the cooling channel 80.

In a preferred embodiment, the fluid that flows through the delivery means 18 is water. However, other fluids such as ethylene glycol can also be used. The inlet fluid tube 84 and the outlet fluid tube 88 are positioned inside of the compliant tube 22. A space 90 exists on the inside of the compliant tube 22 between the inlet fluid tube 84 and the outlet fluid tube 88 and the inside wall of the compliant tube 22. Generally, the space 90 is maintained at atmospheric pressure, while the region outside of the compliant tube 22 is part of the vacuum environment. An advantage of having the inlet fluid tube 84 and the outlet fluid tube 88 positioned inside of the compliant tube 22, is that any fluid that leaks out of the inlet fluid tube 84 or the outlet fluid tube 88 will be contained inside of the compliant tube 22 and will not contaminate the vacuum environment.

As was described previously with respect to FIG. 1, a portion of the fluid delivery means 18 passes through the abutment 32 and extends inside the linear motion bellow 60. This extension of the fluid delivery means 18 allows the inlet fluid tube 84 to be connected to a fluid supply reservoir, and allows the outlet fluid tube 88 to be connected to a return source for processing or disposing of used fluid. Preferably, the inlet fluid tube 84 and the outlet fluid tube 88 are long pieces of tubing comprised of a flexible material such as a plastic or other synthetic material, such as a Tygon® brand material.

FIG. 4 illustrates the manner in which the second weldment 36 connects the connector 14 to the crucible 40. A transition part 94 is mechanically attached to the crucible 40, such as by brazing. A flange 98 provides the interface for the weldment 36. The weldment 36 is welded to the compliant tube 22.

A replaceable, crushable metal seal 102 is positioned between the weldment 36 and the flange 98. The metal seal 102 functions to separate vacuum from atmosphere, and is preferably comprised of copper. The weldment 36 and the flange 98 are held together by multiple fasteners. The fasteners allow the weldment 36 and the flange 98 to be separated from each other, thereby allowing servicing, such as the replacement of the connector 14. Preferably, the transition part 94, the flange 98, and the weldment 36 are all comprised of a material such as stainless steel, although other materials may be used.

FIG. 5 illustrates the attachment means 43 and 44 in more detail. The function of the attachment means 43 and 44 is to connect the actuator rods 24 and 28, respectively, to the plate assembly 64 with enough flexibility to relieve stress on the compliant tube 22 arising from linear and non-linear forces on the connector 14. Preferably, the design of the attachment means 43 and 44 includes one or more degrees of freedom in each of the attachment means to relieve the stress. The plate assembly 64 is connected to the compliant tube 22, such as by welding.

In a preferred embodiment, the attachment means 43 comprises a first bearing pivot 110 and a second bearing pivot 112. The first bearing pivot 110 and the second bearing pivot 112 are connected by a connecting bar 114. The connecting bar 114 connects to the first bearing pivot 110 at a first pivot joint 118. The first pivot joint 118 allows the connecting bar 114 to move a small amount in the direction of an arrow 122 and joint 118 may comprise one or more ball bearings. A second pivot joint 126 in the second bearing pivot 112 allows the connecting bar 114 to move a small amount in the direction of an arrow 130, which represents a direction perpendicular to the direction indicated by the arrow 122, and joint 126 may comprise one or more ball bearings.

Similarly, in a preferred embodiment, the attachment means 44 comprises a first bearing pivot 140 and a second bearing pivot 142. The first bearing pivot 140 and the second bearing pivot 142 are connected by a connecting bar 144. The connecting bar 144 connects to the first bearing pivot 140 at a first pivot joint 148. The first pivot joint 148 allows the connecting bar 144 to move a small amount in the direction of the arrow 122 and joint 148 may comprise one or more ball bearings. A second pivot joint in the second bearing pivot 142 allows the connecting bar 144 to move a small amount in the direction indicated by the arrow 130, analogously to the joint 126, and the second pivot joint may comprise one or more ball bearings. The attachment means 44 functions analogously to the attachment means 43 to connect the actuator rod 28 to the plate assembly 64 with enough flexibility to relieve stress on the compliant tube 22 arising from linear and non-linear forces on the connector 14.

FIG. 6 illustrates that each bearing assembly 62 comprises an upper hub 162, a lower hub 164 and a groove 166. The groove 166 if formed between the hubs 162 and 164 and is sized to accept a rail 170 (shown in FIG. 7) formed in the crucible 40. The bearing assemblies 62 allow the crucible 40 to slide smoothly in the z-direction (shown in FIG. 1) along the rail 170 so that the crucible 40 can be accurately positioned in response to the motion caused by the translation means 56. Each bearing assembly 62 includes a spindle 172 that permits the hubs 162 and 164 to rotate so as to allow the rail 170 to slide smoothly past the assembly 62.

FIG. 7 illustrates that the compliant tube 22 extends through the sealing bellow interface 66 and into a lumen 180 inside of the linear motion bellow 60. The high vacuum environment is maintained in the lumen 180 inside of the sealing bellow interface 66 and is separated from atmospheric pressure by a bellows endplate 184 which is attached to the linear motion bellow 60 in a vacuum-tight manner. The fluid delivery means 18 extends beyond the bellows endplate 184, where it is connected to the fluid supply reservoir, and the region inside of the compliant tube 22 is open to atmospheric pressure where the tube 22 exits the endplate 184.

The translation means 56 (shown in FIG. 1) causes the connector 14 to move by causing an actuator plate 186 to apply force (press on) the bellows endplate 184 to which the plate 186 is connected. The compliant tube 22 is welded to the bellows endplate 184 in a vacuum-tight manner, and thus moves when the bellows endplate 184 moves. The crucible 40 moves along the rail 170 because it is connected to the connector 14 by the second weldment 36. The fluid delivery means 18 moves with the crucible 40 because the fluid delivery means 18 is connected to the crucible 40. The fluid delivery means 18 can move freely inside of the compliant tube 22 and through the end of the endplate 184. The linear motion bellow 60 stretches like an accordion to accommodate the linear motion caused by the actuator plate 186 while maintaining the vacuum environment in the lumen 180.

FIG. 7 also illustrates a vacuum chamber 190 that surrounds the crucible 40 and part of the connector 14, and that is attached to the sealing bellow interface 66. The chamber 190 is capable of maintaining a vacuum environment, such as the vacuum environment required for a thin film plating operation using an electron beam. An electron gun 194 provides the electron beam used in the thin film plating operation.

In a preferred embodiment, the connector 14 is used in an e-beam evaporator. An e-beam evaporator is a physical deposition system that utilizes an electron gun in a high or ultra-high vacuum environment (for example, pressures in the range of approximately 10⁻⁷ ton to 10⁻⁹ torr) to generate an electron beam that vaporizes a source material which is then deposited onto a target as a thin film. An example of such a system is described in U.S. Pat. No. 5,473,627, issued Dec. 5, 1995; although that system utilizes a crucible that rotates, whereas the present invention is used with crucibles that move in a linear direction. The connector 14 could also be used in other systems requiring highly dependable structural components that provide linear transmission and a leak proof fluid delivery system.

In operation, the connector 14 and the crucible 40 are positioned inside of the vacuum chamber 190. The linear motion bellow 60 and the sealing bellow interface 66 provide a vacuum tight connection to the chamber. The translation means 56 moves the connector 14 in the horizontal (z) direction as was described previously. Consequently, the connector 14 moves the crucible 40 in the horizontal (z) direction because the connector 14 is attached to the crucible 40 through the second weldment 36. The bearing assembly 62 allows the crucible 40 to move smoothly and be positioned very precisely.

When the bellows endplate 184, the connector 14 and the crucible 40 are all properly aligned, the compliant tube 22 should experience little or zero stress from the linear motion of the crucible 40 (i.e. the movement in the horizontal (z) direction) as it moves on the bearing assemblies 62. The upper actuator rod 24 and the lower actuator rod 28 act as structural components to bear the load of linear translation and to relieve any stress (or force) that the compliant tube 22 might experience during the linear movement of the crucible 40, such as from minor misalignment. The stress may be linear or non-linear stress. In this sense, non-linear stress means a force that acts on the connector 14 in a direction that is not parallel to the direction of the linear motion (i.e. is not parallel to the horizontal (z) direction); whereas linear stress is stress in the direction of the linear motion.

The actuator rod 24 is able to relieve most, or all, of the non-linear stress because the connecting bar 114 associated with first bearing pivot 110 and the second bearing pivot 112 move small amounts about the first pivot joint 118 and the second pivot joint 126. Similarly, the actuator rod 28 is able to relieve non-linear stress because the connecting bar 144 is able to move about the first pivot joint 148 and the second pivot joint. The reduction of stress on the compliant tube 22 means that the compliant tube 22 is much less likely to develop leaks from the fluid delivery means 18, as is described below.

The fluid delivery means 18 delivers a fluid, such as water, to the region around the pockets 45, 46, 48 and 50 to keep the pockets cool during the electron beam deposition process. In a typical electron beam deposition process, the water in the inlet fluid tube 84 would be at or near room temperature (i.e. about 22° C.) and the water temperature in the outlet fluid tube 88 would be elevated after picking up heat from the pocket being cooled. The fluid delivery means 18 is positioned inside of the compliant tube 22. The compliant tube 22 provides two functions. First, it acts as a secondary containment structure to contain leaks of fluid from the fluid delivery means 18 in the unlikely event that a leak occurs. Second, the bellows section 42 associated with the compliant tube 22 acts to compensate for misalignment between the endplate 184 and the crucible 40 during linear movement, or for other sources of stress on the compliant tube 22. This stress-relieving feature protects the compliant tube 22 from stress that might cause it to leak fluid into the vacuum chamber 190.

In a preferred embodiment, the connector 14 comprises a fluid delivery means for conveying a fluid to a component, a compliant tube that surrounds the fluid delivery means and that is fluid-tight, and load transfer means positioned outside of the compliant tube for relieving stress on the compliant tube that arises while the compliant tube undergoes linear motion. The fluid delivery means may be the inlet fluid tube 84 and/or the outlet fluid tube 88, for conveying a fluid to a component such as the crucible 40. The compliant tube may be the compliant tube 22 that contains the bellows section 42. The load transfer means may comprise the actuator rod 24 and/or the actuator rod 28.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true scope of the invention.

We claim:

1. A connector comprising:
fluid delivery means for conveying a fluid to a component;
a compliant tube that surrounds the fluid delivery means and that is fluid-tight; and
load transfer means positioned outside of the compliant tube for relieving stress on the compliant tube that arises while the compliant tube undergoes linear motion.

2. The apparatus of claim 1 wherein the compliant tube includes at least one bellows section.

3. The apparatus of claim 1 wherein the compliant tube is comprised of a metal.

4. The apparatus of claim 3 wherein the metal comprises stainless steel.

5. The apparatus of claim 1 wherein the fluid delivery means comprises an inlet tube and an outlet tube.

6. The apparatus of claim 1 wherein the load transfer means comprises at least one rod that extends in a direction parallel to the compliant tube.

7. The apparatus of claim 6 wherein the rod is comprised of stainless steel.

8. The apparatus of claim 6 wherein the rod can pivot in at least one direction that is not parallel to the direction of the linear motion.

9. A connector comprising:
one or more fluid delivery tubes for conveying a cooling fluid to a crucible used in a thin film plating operation;
a compliant tube that surrounds the fluid delivery tubes and forms a fluid tight containment structure around the fluid delivery tubes, the compliant tube having at least one bellows section; and
one or more rods positioned outside of the compliant tube and adapted to relieve stress on the compliant tube when the crucible is undergoing linear motion.

10. The apparatus of claim 9 wherein the compliant tube is comprised of a metal.

11. The apparatus of claim 10 wherein the metal comprises stainless steel.

12. The apparatus of claim 9 wherein the one or more fluid delivery tubes comprise an inlet tube and an outlet tube.

13. The apparatus of claim 9 wherein each of the one or more rods extend in a direction parallel to the compliant tube.

14. The apparatus of claim 9 wherein at least one of the one or more rods is comprised of stainless steel.

15. The apparatus of claim 9 wherein at least one of the one or more rods can pivot in a direction that is not parallel to the direction of the linear motion.
